(19) United States
(12) Patent Application Publication
(10) Pub. No.: US 2004/0186643 A1
(43) Pub. Date: Sep. 23, 2004

(54) Pedestrian protection system mounted on vehicle

(76) Inventors: Taichi Tanaka, Chiryu-city (JP); Shigenori Kobayashi, Hazu-gun (JP)

Correspondence Address: POSZ & BETHARDS, PLC, 11250 ROGER BACON DRIVE, SUITE 10, RESTON, VA, 20190, US

(21) Appl. No.: 10/800,725

(22) Filed: Mar. 16, 2004

(30) Foreign Application Priority Data
Mar. 19, 2003 (JP) 2003-75128

(51) Int. Cl. B60R 22/00

(52) U.S. Cl. 701/45; 180/274; 296/187.04

(57) ABSTRACT

Upon detecting a collision with a pedestrian, a rear side of a vehicle hood which is hinged at its front side is quickly lifted in order to alleviate a secondary impact on the pedestrian who is first hit by a front bumper. To detect the collision with a pedestrian without fail, a plurality of load sensors are mounted on the bumper, and the detection of the collision is made based on an output signal from each one of the load sensors. Thus, the collision with a pedestrian can be accurately distinguished from a collision with obstacles other than a pedestrian.

### CROSS-REFERENCE TO RELATED APPLICATION

This application is based upon and claims benefit of priority of Japanese Patent Application No. 2003-75128 filed on Mar. 19, 2003, the content of which is incorporated herein by reference.

### BACKGROUND OF THE INVENTION

1. Field of the Invention

The present invention relates to a device for protecting a pedestrian from a collision impact, and more particularly, to a device for alleviating a secondary impact given to a pedestrian when a vehicle collides therewith.

2. Description of Related Art

An example of a pedestrian protecting system is disclosed in JP-A-11-28994. This system includes a pedestrian detector and a vehicle speed sensor. When output signals generated, at a collision, in the pedestrian detector and the vehicle speed sensor coincide with predetermined conditions, it is determined that the vehicle collides with a pedestrian, and a vehicle hood hinged at its front end is popped up. Thus, a secondary impact on the pedestrian who is first hit with a bumper of the vehicle is alleviated by the popped up hood. The pedestrian detector is composed of a load sensor or a displacement sensor mounted on a front bumper.

In the above system, it is determined that the vehicle collides with an obstacle or obstacles other than a pedestrian if the output level of the pedestrian detector exceeds a predetermined level. If the vehicle simultaneously hits more than one person, the output level of the pedestrian detector exceeds the predetermined level, and it is determined that the vehicle collides with an obstacle other than a person, such as a wall, a tree or another vehicle. Therefore, the hood is not popped up under this situation. Further, if the vehicle simultaneously hits a person and an obstacle, the hood is not popped up.

The output level of the pedestrian detector becomes higher as a vehicle speed becomes higher. In the above conventional system, however, a threshold for determining that the vehicle collides with a person is set to a constant level irrespective of the vehicle speed. Therefore, there will be a higher chance of misjudgment as the vehicle speed becomes higher.

### SUMMARY OF THE INVENTION

The present invention has been made in view of the above-mentioned problem, and an object of the present invention is to provide an improved pedestrian protection system in which a collision with a pedestrian is surely detected even if the vehicle hits plural pedestrians or simultaneously hits a pedestrian and another obstacle.

The pedestrian protection system according to the present invention includes: a plurality of load sensors mounted on a front bumper and aligned in the longitudinal direction of the bumper; an acceleration sensor for detecting acceleration of a vehicle; a speed sensor for detecting a vehicle speed; and an electronic control unit for actuating a pedestrian protection device based on output signals of the sensors. The electronic control unit determines whether the vehicle collides with a pedestrian or other obstacles based on the output signals from each one of the plurality of load sensors and the acceleration sensor.

When it is determined that the vehicle collides with a pedestrian, a pedestrian protection device is actuated to alleviate a secondary impact on the pedestrian who is first hit with the front bumper. For example, a hood of the vehicle that is hinged at its front end is popped up around the front hinge to receive the pedestrian with it. In this manner, the secondary impact imposed on the pedestrian is alleviated. As the pedestrian protection device, an airbag adapted to be inflated on the hood may be used.

Since the collision with a pedestrian is detected based on the output signal from each one of the load sensors, the collision with a pedestrian is detected without fail. If the output signal from any one of the load sensors indicates the collision with a pedestrian, it is determined that the vehicle collides with a pedestrian even if output signals from other load sensor indicate a collision with obstacles other than a pedestrian. Preferably, threshold levels for determining the collision with a pedestrian are changed according to the vehicle speed to make the determination further accurate in a wide range of the vehicle speed. The plurality of load sensors mounted on the front bumper may be replaced with a plurality of pressure sensors or a plurality of displacement sensors.

Other objects and features of the present invention will become more readily apparent from a better understanding of the preferred embodiment described below with reference to the following drawings.

### BRIEF DESCRIPTION OF THE DRAWINGS

FIG. 1 is a perspective view showing a vehicle on which a pedestrian protection system according to the present invention is mounted;

FIG. 2 is a block diagram showing an electrical circuit in the pedestrian protection system;

FIG. 3 is a plan view showing a load sensor having plural sensor cells formed on a sensor film;

FIG. 4A is a partial schematic view showing an example of positions where the load sensors are mounted;

FIG. 4B is a partial schematic view showing another example of positions where the load sensors are mounted;

FIG. 5 is a flowchart showing a process of determining a collision with a pedestrian and actuating a protection device, in a first embodiment of the present invention;

FIG. 6 is a graph showing output levels of load sensors after a collision occurred; and

FIG. 7 is a flowchart showing a process of determining a collision with a pedestrian and actuating a protection device, in a second embodiment of the present invention.

### DETAILED DESCRIPTION OF THE PREFERRED EMBODIMENTS

### First Embodiment

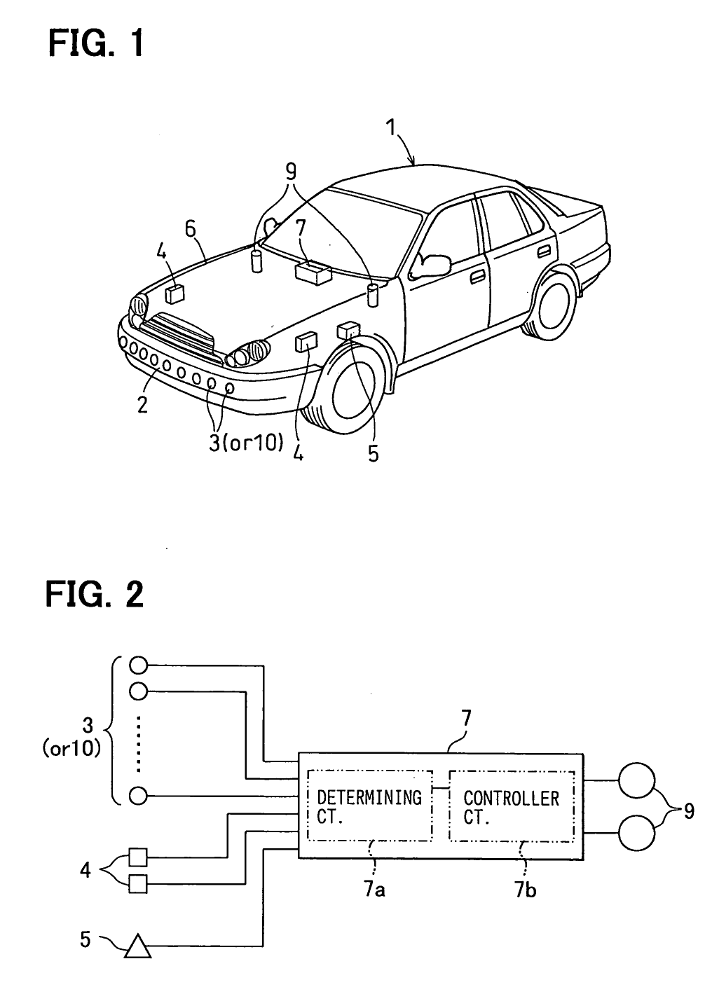

A first embodiment of the present invention will be described with reference to FIGS. 1-6. FIG. 1 shows a vehicle 1 on which a pedestrian protection system according to the present invention is mounted. The pedestrian protection system includes: load sensors 3 mounted on a front bumper 2; acceleration sensors 4 installed in an engine compartment; a speed sensor 5 for detecting a vehicle speed (a traveling speed of a vehicle); actuators 9 for popping up a hood 6 that is hinged at it front end; and an electronic control unit (ECU) 7 for determining a collision with a pedestrian and for actuating the actuator 9.

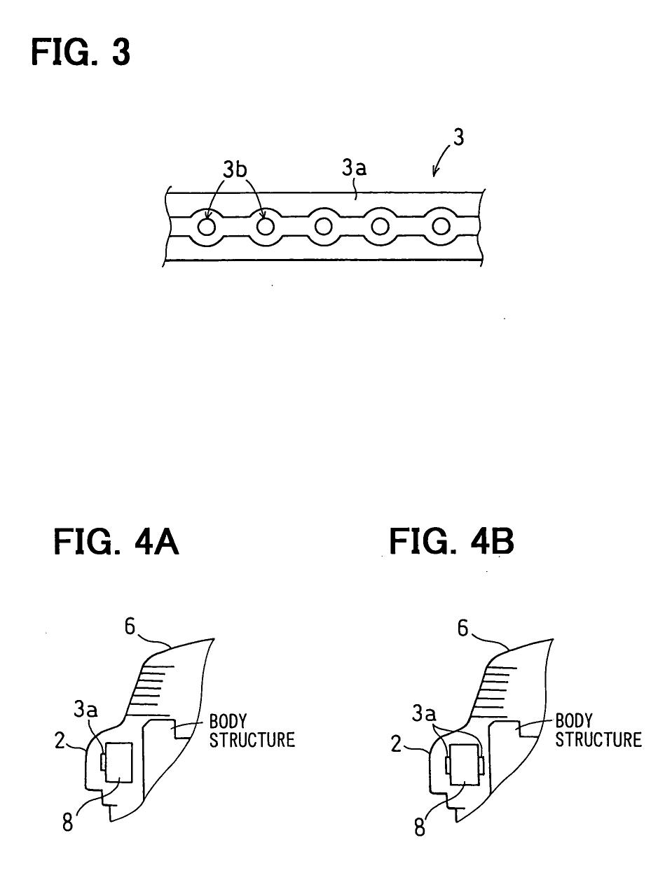

As shown in FIG. 3, plural sensor cells 3b are formed on a sensor film 3a by, e.g., a screen printing process. The sensor cells 3b function as the load sensors that output signals (electrical voltages) according to impact loads imposed thereon. The sensor film 3a is attached to the front surface of a shock absorber 8 positioned in a front bumper 2, as shown in FIG. 4A. The plural load sensors are aligned along the longitudinal direction of the front bumper 2 at equal intervals. Alternatively, one sensor film 3a is attached to the front surface of the shock absorber 8 and the other sensor film 3a to the rear surface, as shown in FIG. 4B.

The load sensors 3 positioned on the front surface quickly response to collision impacts. When the load sensors 3 are positioned on both the front and rear surfaces, the front sensors 3 may be used for detecting collision impacts at a lower vehicle speed, while the rear sensors 3 may be used for detecting those at a higher vehicle speed. When the vehicle is driving at a high speed, a pedestrian hit by the front bumper 2 generates a high level signal in the load sensors 3. Accordingly, there is a possibility to make a misjudgment that the vehicle hits a heavy obstacle even when the vehicle actually hits a pedestrian. If the load sensors 3 located at the rear side are used when the vehicle is driving at a high speed, the sensor signals generated at a collision with a pedestrian are attenuated through the shock absorber 8. Accordingly, discrimination between a pedestrian and a heavy obstacle will be made more easily.

The acceleration sensors 4 are positioned in the front portion of the engine compartment at both sides thereof, as shown in FIG. 1. In this manner, acceleration of the vehicle at a collision is precisely detected, and signals representing the detected acceleration are fed to the electronic control unit 7. The speed sensor 5 detects, for example, rotational speed of a front axle and sends electrical signals in a pulse form to the electronic control unit 7.

The hood 6 of the vehicle 1 is hinged at its front side, and its rear side is locked by a pair of actuators 9. The actuator 9 may be composed of a cylinder operated by oil pressure, for example. When a collision with a pedestrian is detected, the hood 6 locked by the actuators 9 at its rear side is released and pops up around its front hinge. In other words, the rear side of the hood 6 is quickly lifted, and thereby the pedestrian hit by the front bumper 2 is received by the lifted hood 6. Accordingly, the secondary collision impact on the pedestrian is alleviated by the popped up hood 6.

As shown in FIG. 2, the electronic control unit 7 includes a determining circuit 7a that determines whether the vehicle hits a pedestrian or other obstacles and a controller circuit 7b that operates the actuators 9 upon detection of the collision with a pedestrian. Output signals from the load sensors 3, the acceleration sensors 4 and the speed sensor 5 are all fed to the electronic control unit 7.

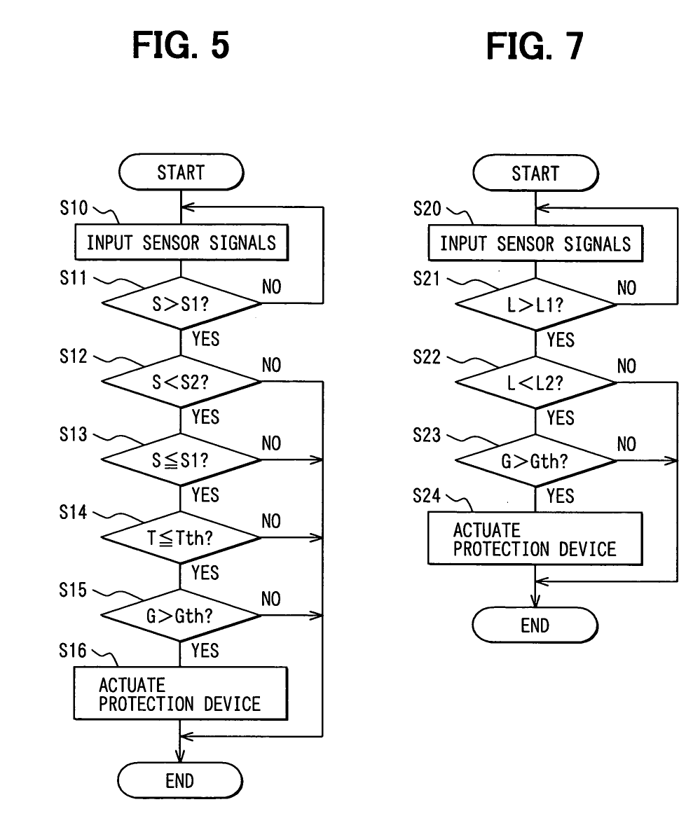

Now, a process of determining whether the vehicle collides with a pedestrian and actuating the protection device upon detection of such collision will be described with reference to FIG. 5. At step S10, the output signals from the load sensors 3, the acceleration sensors 4 and the speed sensor 5 are all fed to the electronic control unit 7. At step S11, it is determined whether an output S of any one of the load sensors 3 is higher than a first predetermined load level S1 which is a threshold level indicating a possibility of a collision with a pedestrian. If S is higher than S1, the process proceeds to the next step S12, and if not, the process returns to S10. At step S12, it is determined whether the output S is lower than a second predetermined load level S2 which is higher than S1 and indicates a possibility of a collision with an obstacle other than a pedestrian.

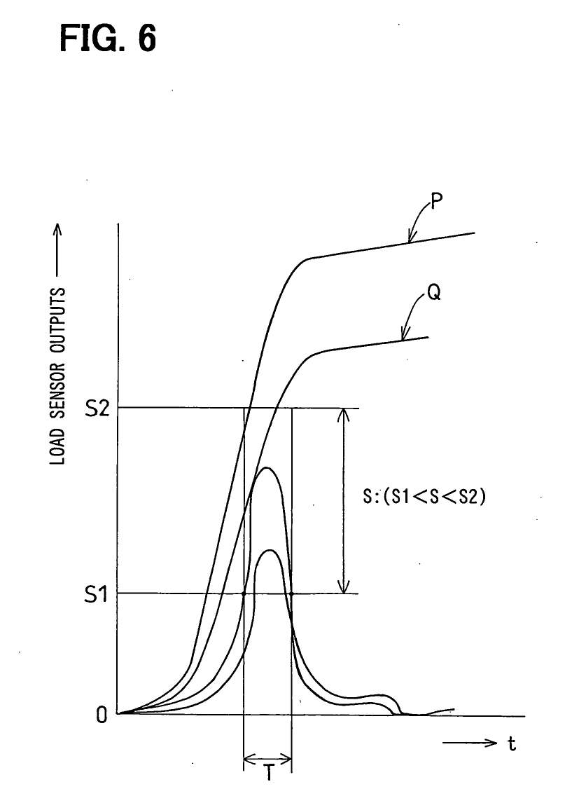

FIG. 6 shows output levels (impact loads) of the load sensor 3 under various situations. A curve “P” shows impact loads appearing when the vehicle collides with another vehicle or a wall. A curve “Q” shows impact loads appearing when the vehicle hits a tree, an electricity pole or a stationary sign pole. Two curves below the curves P and Q show impact loads appearing when the vehicle collides with a pedestrian. As seen in the graph, the impact loads appearing upon a collision with a pedestrian are much lower than those appearing upon hitting other obstacles. The impact loads appearing upon hitting obstacles exceed the second predetermined load level S2. On the other hand, the impact loads appearing upon colliding with a pedestrian quickly decrease below the first predetermined load level S1. Based on the phenomena described above, the electronic control unit 7 determines the collision with a pedestrian.

Then, at step S13, it is determined whether the output S has decreased to a level equal to or lower than the first predetermined load level S1. At the next step S14, it is determined whether a time period T during which S is higher than S1 is shorter than a predetermined threshold time period Tth. If T is shorter than Tth, there is a high possibility that a collision with a pedestrian occurred. This is because the impact loads appearing upon collision with a pedestrian quickly decrease as shown in the graph of FIG. 6. On the other hand, the impact loads appearing upon hitting other obstacles do not decrease quickly.

At step S15, it is determined whether the output G of the acceleration sensor 4 exceeds a predetermined acceleration level Gth. It is determined that the collision with a pedestrian occurred if G is higher than Gth. Then, at the next step S16, the actuators 9 are operated to pop up the hood 6. The second collision impacts on the pedestrian are alleviated by the popped up hood 6.

The first predetermined load level S1, the second predetermined load level S2, the predetermined threshold time period Tth, and the predetermined acceleration level Gth are all adjusted according to the vehicle speed detected by the speed sensor 5.

In the process described above, the collision with a pedestrian is determined based on the output signal S from each one of plural load sensors 3. In other words, if the output signal S of any one of the load sensors 3 indicates the collision with a pedestrian, it is determined that there occurred a collision with a pedestrian even if the output signals from other load sensors 3 indicate the collision with obstacles other than a pedestrian. Therefore, if the vehicle hits plural persons and if the total output from the load sensors 3 is high, indicating a collision with other obstacles, the electronic control unit 7 determines that there occurred a collision with a pedestrian as long as one of the load sensor 3 indicates the collision with a pedestrian.

The above is also applicable when the vehicle simultaneously collides with a pedestrian and other obstacles. That is, as long as any one of the load sensors indicates a collision with a pedestrian, it is determined that a collision with a pedestrian occurred irrespective of output signals from other load sensors 3. In this manner, the collision with a pedestrian is detected without fail, and accordingly the second collision impacts on the pedestrian are surely alleviated by the pedestrian protection device, i.e., the popped up hood 6.

Since the collision with a pedestrian is detected not only based on the output signals of the load sensors 3 but also based on the outputs of the acceleration sensors 4 and the speed sensor 5, possible misjudgments can be avoided. Further, the predetermined threshold levels, S1, S2, Tth and Gth are adjusted according to the vehicle speed detected by the speed sensor 5, the detection is precisely performed in a wide range of the vehicle speed.

### Second Embodiment

In this embodiment, displacement sensors 10 (refer to FIG. 1) are used in place of the load sensors 3. Other structures are the same as those of the first embodiment. A process of detecting the collision with a pedestrian and actuating the pedestrian protection device, performed in this second embodiment, will be described with reference to FIG. 7.

At step S20, the output signals from all the sensors, i.e., the displacement sensors 10, the acceleration sensors 4 and the speed sensor 5, are fed to the electronic control unit 7. At step S21, it is determined whether an output L from any one of the displacement sensors 10 is higher than a first predetermined displacement level L1 indicating a possibility of a collision with a pedestrian. At step S22, it is determined whether L is lower than a second predetermined displacement level L2 indicating a possibility of a collision with other obstacles. L2 is set higher than L1.

At step S23, it is determined whether the acceleration G detected by the acceleration sensors 4 is higher than a predetermined acceleration level Gth. It is determined that a collision with a pedestrian occurred if G is higher than Gth. At step S24, the pedestrian protection device is operated by actuating the actuators 9. The threshold levels, i.e., L1, L2 and Gth are adjusted according to the vehicle speed detected by the speed sensor 5 in the same manner as in the first embodiment.

Since the collision with a pedestrian is detected based on the output signal from each one of the displacement sensors 10, in the same manner as in the first embodiment, such collision can be surely detected. Since the threshold levels, L1, L2 and Gth are adjusted according to the vehicle speed, the collision with a pedestrian can be detected with a high accuracy in a wide range of the vehicle speed.

The present invention is not limited to the embodiments described above, but it may be variously modified. For example, in place of the load sensors 3, pressure sensors may be mounted on the front bumper 2. Though the pedestrian is protected by popping up the hood 6 in the foregoing embodiments, it is also possible to use an airbag that is inflated on the hood 6 upon detecting a collision with a pedestrian. It is also possible to additionally use a detector for detecting a size of obstacles, such as a radar, an infrared sensor or a millimeter-wave sensor. By using such a detector for detecting an obstacle size, reliability of detection can be further improved.

While the present invention has been shown and described with reference to the foregoing preferred embodiments, it will be apparent to those skilled in the art that changes in form and detail may be made therein without departing from the scope of the invention as defined in the appended claims.

What is claimed is:

1. A pedestrian protection system by alleviating a secondary impact on a pedestrian when a vehicle collides with a pedestrian, the pedestrian protection system comprising:
means for alleviating a collision impact on a pedestrian;
a plurality of load sensors or pressure sensors mounted on a front bumper of the vehicle and aligned in the longitudinal direction of the bumper;
an acceleration sensor for detecting acceleration of the vehicle;
a speed sensor for detecting a traveling speed of the vehicle;
means for determining whether an obstacle colliding with the vehicle is a pedestrian based on output signals from the load sensors or the pressure sensors, the acceleration sensor and the speed sensor; and
a controller device that actuates the alleviating means when the determining means determines that the obstacle colliding with the vehicle is a pedestrian, wherein:
the determining means performs its determination based on the output signal from each one of the plurality of the load sensors or the pressure sensors.

2. A pedestrian protection system by alleviating a secondary impact on a pedestrian when a vehicle collides with a pedestrian, the pedestrian protection system comprising:
means for alleviating a collision impact on a pedestrian;
a plurality of displacement sensors mounted on a front bumper of the vehicle and aligned in the longitudinal direction of the bumper;
an acceleration sensor for detecting acceleration of the vehicle;
a speed sensor for detecting a traveling speed of the vehicle;
means for determining whether an obstacle colliding with the vehicle is a pedestrian based on output signals from the displacement sensors, the acceleration sensor and the speed sensor; and
a controller device that actuates the alleviating means when the determining means determines that the obstacle colliding with the vehicle is a pedestrian, wherein:
the determining means performs its determination based on the output signal from each one of the plurality of the displacement sensors.

3. The pedestrian protection system as in claim 1, wherein:
the determining means changes threshold levels for determining that the obstacle colliding with the vehicle is a pedestrian according to the traveling speed of the vehicle detected by the speed sensor.

4. The pedestrian protection system as in claim 2, wherein:
the determining means changes threshold levels for determining that the obstacle colliding with the vehicle is a pedestrian according to the traveling speed of the vehicle detected by the speed sensor.

5. The pedestrian protection system as in claim 1, wherein:
the alleviating means is a device for popping up a vehicle hood that is hinged at a front end thereof.

6. The pedestrian protection system as in claim 2, wherein:
the alleviating means is a device for popping up a vehicle hood that is hinged at a front end thereof.

7. The pedestrian protection system as in claim 3, wherein:
the alleviating means is a device for popping up a vehicle hood that is hinged at a front end thereof.

8. The pedestrian protection system as in claim 1, wherein:
the alleviating means is an airbag adapted to be inflated on the vehicle hood.

9. The pedestrian protection system as in claim 2, wherein:
the alleviating means is an airbag adapted to be inflated on the vehicle hood.

10. The pedestrian protection system as in claim 3, wherein:
the alleviating means is an airbag adapted to be inflated on the vehicle hood.
